(19) United States
(12) Patent Application Publication
(10) Pub. No.: US 2025/0038278 A1
(43) Pub. Date: Jan. 30, 2025

(54) BATTERY

(71) Applicant: EVE POWER CO., LTD., JINGMEN (CN)

(72) Inventors: RUIRUI ZHAO, JINGMEN (CN); PENGCHENG LIU, JINGMEN (CN); LIANGLIANG LIU, JINGMEN (CN); DONGRONG QI, JINGMEN (CN)

(21) Appl. No.: 18/540,908

(22) Filed: Dec. 15, 2023

(30) Foreign Application Priority Data
Jul. 25, 2023 (CN) 202321965532.X

(51) Int. Cl. H01M 10/42; H01M 10/48; H01M 50/103

(52) U.S. Cl. CPC H01M 10/425; H01M 10/486; H01M 50/103; H01M 2010/4278

(57) ABSTRACT

A battery includes an outer housing and a cell. The cell is received in a first receiving cavity of the outer housing, the outer housing is arranged with an insulating member. At least one information obtaining component is received in the first receiving cavity and fixed to the cell. Each information obtaining component includes a detection assembly, a power supply battery, a wireless transmitting end and a circuit board. A detection end of the detection assembly is attached to the cell, the wireless transmitting end is disposed adjacent to the insulating member and is configured to transmit a signal, and the signal is capable of transmitting through the insulating member to reach an exterior of the first receiving cavity.

### CROSS REFERENCE TO RELATED APPLICATIONS

The present application claims priority of Chinese patent application No. 202321965532.X, filed on Jul. 25, 2023, and contents of which are incorporated herein by its entireties.

### TECHNICAL FIELD

The present disclosure relates to the field of electric energy storage devices, and in particular to a battery.

### BACKGROUND

In the art, internal information of a large-sized battery may be obtained by arranging an external component, and that is, an information obtaining component is disposed out of the battery. An obtaining end of the information obtaining component may be insulated with a battery cover and extends through the battery cover to reach an interior of the battery. In addition, the battery, which has information to be obtained, supplies power to the information obtaining component. The above structure has the following problems.

1. The information obtaining component consumes a current of the battery. The information obtaining component itself has power consumption. The information obtaining component may fail in a processing process. In this case, the power consumption may be increased, and therefore, reliability of an overall system of the battery may be affected, resulting in battery failure.

2. Original battery cover elements may need to be re-modified, such that complexity of the battery cover may be improved, costs of the battery cover may be increased, and reliability of the battery cover may be reduced.

3. A process of assembling the battery is complex. An existing production line needs to be changed dramatically and may not be promotively applied.

### SUMMARY OF THE DISCLOSURE

Embodiments of the present disclosure provide a battery. An information obtaining component of the battery has less influence on an overall system of the battery. A structure of the battery is simple, and a production cost of the battery is low.

In an aspect, the present disclosure provides a battery, including an outer housing and a cell. The cell is received in a first receiving cavity of the outer housing, the outer housing is arranged with an insulating member. At least one information obtaining component is received in the first receiving cavity and fixed to the cell. Each of the at least one information obtaining component includes a detection assembly, a power supply battery, a wireless transmitting end and a circuit board. The detection assembly, the power supply battery, and the wireless transmitting end are electrically connected with each other via the circuit board. A detection end of the detection assembly is attached to the cell, the wireless transmitting end is disposed adjacent to the insulating member and is configured to transmit a signal, and the signal is capable of transmitting through the insulating member to reach an exterior of the first receiving cavity.

In some embodiments, the battery further includes a pole, extending through the insulating member and the outer housing. The insulating member is disposed between an end of the pole and the outer housing, the other end of the pole is received in the first receiving cavity; and the at least one information obtaining component is arranged on a side of the cell near the pole.

In some embodiments, the detection assembly includes a detection signal line. An end of the detection signal line is connected to the circuit board, the other end of the detection signal line is arranged with the detection end. The cell comprises a first cell pack and a second cell pack, the detection signal line is disposed between the first cell pack and the second cell pack. The detection end is configured to detect information of a first attachment face of the first cell pack and information of a second attachment face of the second cell pack, and the attachment face is a surface to which the detection end is attached.

In some embodiments, a heat-homogenization plate is arranged on both the first cell pack and the second cell pack; the heat-homogenization defines an avoidance groove; and the detection signal line is received in the avoidance groove.

In some embodiments, each of the at least one information obtaining component further includes a sealing shell. The sealing shell has a second receiving cavity; the power supply battery, the wireless transmitting end, and the circuit board are received in the second receiving cavity.

In some embodiments, the battery further includes a pole, extending through the outer housing. The pole is connected to the cell, the sealing shell abuts against a circumferential face of the pole, and the sealing shell is insulated from the pole.

In some embodiments, the sealing shell is non-metallic.

In some embodiments, the insulating member is disposed between the pole and the outer housing, and the sealing shell abuts against the insulating member.

In some embodiments, the at least one information obtaining component is adhered to the cell.

In some embodiments, the number of the at least one information obtaining component is at least two.

In some embodiments, the number of the at least one information obtaining component is two, the cell has a mounting face, a tab is arranged on the mounting face, the two information obtaining components are arranged on the mounting face, the tab is disposed between the two information obtaining components.

In some embodiments, the cell includes a first cell pack and a second cell pack; one of the two information obtaining components is configured to detect information on a first attachment face of the first cell pack; and the other one of the two information obtaining components is configured to detect information on a second attachment face of the second cell pack.

In some embodiments, the detection signal line includes a temperature signal line and a pressure signal line. The information of the attachment face comprises a temperature of the attachment face and a pressure of the attachment face. The temperature signal line is configured to detect the temperature of the attachment face; and the pressure signal line is configured to detect the pressure of the attachment face.

According to the present disclosure, the information obtaining component is disposed inside the battery and transmits the obtained information to the exterior of the battery by transmitting wireless signals. In this way, an additional hole does not need to be defined in the case of the battery, such that the production cost of the battery is reduced, and versatility of the information obtaining component is improved. The power supply battery is disposed inside the information obtaining component. That is, the information obtaining component has an independent power supply, the information obtaining component operates independently. On the one hand, the information obtaining component does not consume the electrical energy of the battery. On the other hand, a risk that failure of the information obtaining component causes systematic failure of the entire battery may be reduced, ensuring reliability of the cell of the battery. The wireless transmitting end is disposed adjacent to the insulating member. In this way, wireless signals emitted by the wireless transmitting end may not be shielded internally, ensuring the wireless transmitting end to successfully transmit the obtained information of the battery to the exterior of the battery.

### BRIEF DESCRIPTION OF THE DRAWINGS

The present disclosure is described in further detail below by referring to the accompanying drawings and embodiments.

FIG. 1 is an exploded view of a battery according to an embodiment of the present disclosure.

FIG. 2 is a schematic view showing positions of a signal detecting component and a cover according to an embodiment of the present disclosure.

FIG. 3 is a schematic view of the signal detecting component according to an embodiment of the present disclosure.

In the drawings:
1, insulating member; 2, outer housing; 21, case; 22, cover; 3, information obtaining component; 31, power supply battery; 32, circuit board; 33, wireless transmitting end; 34, detection signal line; 341, temperature signal line; 342, pressure signal line; 35, sealing shell; 351, second receiving cavity; 4, pole; 5, cell; 51, first cell pack; 52, second cell pack; 53, tab; 54, mounting face; 6, connector; 7, bottom sheet; 8, protective film.

### DETAILED DESCRIPTION

In order to illustrate the technical problems to be solved by the present disclosure, technical solutions provided by the present disclosure, and technical effects achieved by the present disclosure more clearly, the technical solutions of the embodiments of the present disclosure will be described in further detail in the following by referring to the accompanying drawings. Obviously, the described embodiments show only a part of but not all of the embodiments of the present disclosure. All other embodiments, which are obtained by any ordinary skilled person in the art based on the embodiments in the present disclosure without any creative work, shall fall within the scope of the present disclosure.

In the description of the present disclosure, unless otherwise expressly provided and limited, the terms “connected”, “coupled”, and “fixed” shall be understood broadly. For example, the terms may mean fixed connection, detachable connection or structures being configured as a one-piece and integral structure; mechanical connection or electrical connection; direct connection or indirect connection through an intermediate medium; two elements being internally connected with each other or an interaction between two elements. Any ordinary skilled person in the art shall understand the specific meaning of the above terms herein depending on specific cases.

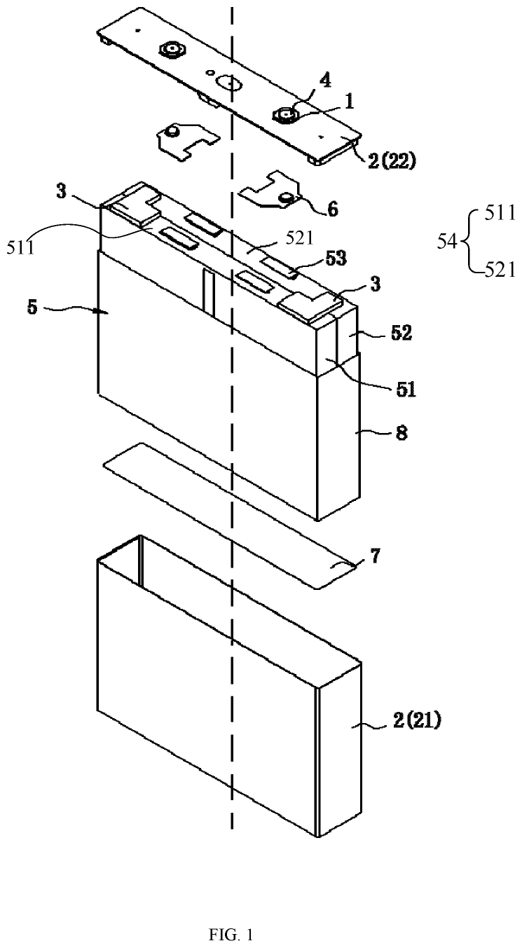

As shown in FIG. 1 and FIG. 2, the present disclosure provides a battery, including an outer housing 2 and a cell 5. The cell 5 is received in a first receiving cavity of the outer housing 2. The outer housing 2 is arranged with an insulating member 1. An information obtaining component 3 is received in the first receiving cavity. The information obtaining component 3 is fixed to the cell 5. The information obtaining component 3 includes a detection assembly, a power supply battery 31, a wireless transmitting end 33, and a circuit board 32. The detection assembly, the power supply battery 31, and the wireless transmitting end 33 are electrically connected to each other through the circuit board 32. An detection end of the detection assembly is attached to the cell 5. The wireless transmitting end 33 is disposed adjacent to the insulating member 1, such that a signal emitted by the wireless transmitting end 33 may pass through the insulating member 1 to reach an exterior of the first receiving cavity. For example, the wireless transmitting end 33 is disposed at an end of the information obtaining component 3 near the insulating member 1. The insulating member 1 may have a first orthographic projection on a cover 22 of the outer housing 2, and a side of the information obtaining component 3 near the wireless transmitting end 33 may have a second orthographic projection on the cover 22 of the outer housing 2. The first orthographic projection may be connected to the second orthographic projection. In some embodiments, there may be no intersection between the first orthographic projection and the second orthographic projection, as long as a distance between the two projections allows the signal emitted by the wireless transmitting end 33 to pass through the insulating member 1 to reach the exterior of the receiving cavity. Since the information obtaining component 3 is disposed inside the battery and the obtained information are transmitted to the outside by transmitting wireless signals, the outer housing 2 may not define any hole. In this way, the production cost of the battery may be reduced, and versatility of the information obtaining component 3 may be improved. The power supply battery 31 is arranged inside the information obtaining component 3, i.e., the information obtaining component 3 has an independent power supply, the information obtaining component 3 operates independently. On the one hand, the information obtaining component 3 does not consume any electrical energy of the battery. On the other hand, failure of the information obtaining component 3 may not cause any systemic risk of the overall battery, ensuring reliability of the cell 5. Since the wireless transmitting end 33 is disposed adjacent to the insulating member 1, the wireless signals emitted by the wireless transmitting end 33 may not be shielded internally, ensuring the wireless transmitting end 33 to successfully transmit the obtained battery information to the exterior of the battery.

In the present embodiment, the outer housing 2 is made of metal. The outer housing 2 includes a case 21 and a cover 22. The case 21 is an aluminium case, and the insulating member 1 is arranged on the cover 22.

Further, the pole 4 extends through the insulating member 1 and the cover 22. That is, the insulating member 1 is disposed between an end of the pole 4 and the outer housing 2. The other end of the pole 4 extends through the insulating member 1 and the cover 22 to be further received in the first receiving cavity. The information obtaining component 3 is arranged on a side of the cell 5 near the pole 4. In the present embodiment, the insulating member 1 and the pole 4 are inherently arranged in the battery, and since the information obtaining component 3 is disposed on the side of the cell 5 near the pole 4, the structures, which are inherently arranged in the battery, may be configured to assist in transmitting the wireless signals. In this way, the case 2 is not arranged with any additional insulating structure, and the production cost of the battery is reduced.

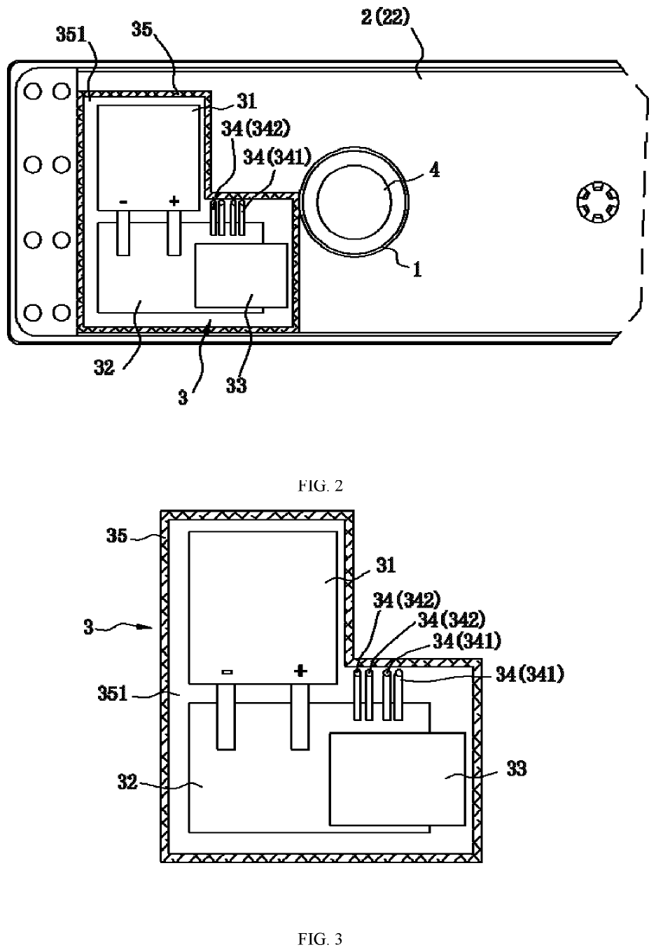

As shown in FIG. 2 and FIG. 3, the detection assembly further includes a detection signal line 34. An end of the detection signal line 34 is connected to the circuit board 32, and the other end of the detection signal line 34 is arranged with a detection end. The cell 5 includes a first cell pack 51 and a second cell pack 52. The detection signal line 34 is disposed between the first cell pack 51 and the second cell pack 52. The detection end detects an attachment face of the first cell pack 51 and an attachment face of the second cell pack 52. Specifically, the first cell pack 51 has a first attachment face 511 facing the cover 22, and the second cell pack 52 has a second attachment face 521 facing the cover 22. That is, the detection end detects information of the first attachment face 511 of the first cell pack 51 and the second attachment face 521 of the second cell pack 52. It can be understood that, the first cell pack 51 and the second cell pack 52 generate heat while being operating. Heat of a part the first cell pack 51 for attachment and heat of a part of the second cell pack 52 for attachment may not be dissipated easily. That is, the first attachment face of the first cell pack 51 and the second attachment face of the second cell pack 52 are locations where heat can be gathered and the highest temperature can be generated. By setting the detection end on the first attachment face of the first cell pack 51 and the second attachment face of the second cell pack 52, the highest temperature of the cell 5 can be detected, such that a current state of the battery can be determined accurately.

In some embodiments, a heat-homogenization plate (not shown in the drawings) is arranged on both the first cell pack 51 and the second cell pack 52. The heat-homogenization plate defines an avoidance groove. The avoidance groove is defined to receive the detection signal line 34. It is understandable that, while the battery is being charged and discharged, various parts of the first attachment face of the first cell pack 51 and the second attachment face of the second cell pack 52 may have different temperatures. However, a range that can be detected by the detection end is limited. The detection end may detect a temperature of a point-sized region and may not be able to detect various regions of the attachment faces. The heat-homogenization plate is arranged on both the first cell pack 51 and the second cell pack 52. Therefore, heat accumulated locally in the first cell pack 51 and the second cell pack 52 may be transmitted to the detection end through the heat-homogenization plate, such that the detection end may accurately detect an actual temperature of the first cell pack 51 and the second cell pack 52. Accuracy of the detection is improved. In the present embodiment, the heat-homogenization plate is a copper plate.

Further, the information obtaining component 3 further includes a sealing shell 35. The sealing shell 35 has a second receiving cavity 351. The power supply battery 31, the wireless transmitting end 33, and the circuit board 32 are received in the second receiving cavity 351. It is understood that the first receiving cavity of the outer housing 2 is filled with electrolyte. While the battery is being charged and discharged, charged particles may enter the electrolyte to electrify the electrolyte. Since the power supply battery 31, the wireless transmitting end 33, the circuit board 32 and other structures of the information obtaining component 3 are received in the second receiving cavity 351 of the sealing shell 35, the above structures may be prevented from contacting the electrolyte, such that the information obtaining component 3 may not have a short circuit due to being interfered by the electrolyte. On the other hand, since the rest elements of the information obtaining component 3 are received in the second receiving cavity 351 of the sealing shell 35, integration of the information obtaining component 3 is improved, enabling the information obtaining component 3 to be mounted and fixed easily. In the present embodiment, an end of the detection signal line 34 is connected to the circuit board 32, and the other end of the detection signal line 34 is the detection end. The detection end passes through the sealing shell 35 to be received in the avoidance groove and to be attached to the heat-homogenization plate and a portion of a surface of the cell 5. The portion of the surface of the cell 5 attached with the detection end serve as a groove wall of the avoidance groove.

In the present embodiment, the case 22 of the outer housing 2 is arranged with a pole 4, and the pole 4 extends through the case 22. The pole 4 is connected to the cell 5. The sealing shell 35 abuts against a circumferential face of the pole 4. The sealing shell 35 is insulated from the pole 4. In the present embodiment, the information obtaining component 3 is fixed to the cell 5. The cell 5 has a mounting face 54 (formed by the first attachment face 511 of the first cell pack and the second attachment face 521 of the second cell pack). The mounting face 54 is arranged with a tab 53. The information obtaining component 3 is disposed on the mounting face 54. That is, the information obtaining component 3 is disposed in a space between the cell 5 and the cover 22. It can be understood that the battery of the present disclosure may have a large capacity. A size of the battery may be large accordingly. Since a space needs to be reserved for connecting the tab 53 of the cell 5 to the pole 4 on the cover 22, the space between the cell 5 and the cover 22 is generated. When the information obtaining component 3 is received in the space, the outer housing 2 may be adapted to the information obtaining component 3 without modifying the structure of the outer housing 2. On the one hand, versatility of the outer housing 2 is improved. On the other hand, an energy density of the battery may not be reduced. Since the sealing shell 35 abuts against the circumferential face of the pole 4, contact positioning between the sealing shell 35 and the pole 4 may be achieved, such that assembling the sealing shell 35 and the pole 4 may be less difficult.

In an embodiment, the sealing shell 35 is a non-metallic shell. Since the sealing shell 35 is non-metallic, the entire sealing shell 35 is insulated. Any conductive material from the outside may not enter the second receiving cavity 351 of the sealing shell 35, elements in the second receiving cavity 351 may not have short circuits. Exemplarily, the sealing shell 35 may be made of polyethylene glycol terephthalate (PET), polypropylene (PP); the sealing shell 35 may be shaped by film blister moulding. Alternatively, the sealing shell 35 may be formed by injection moulding, and treatments of high-frequency welding and ultrasonic waves may be performed to achieve sealing and insulating. The sealing shell 35 may be overall L-shaped to allow the power supply battery 31, the circuit board 32, and the wireless transmitting end 33 to be arranged conveniently.

In another embodiment, the insulating member 1 is disposed between the pole 4 and the cover 22 of the outer housing 2. The sealing shell 35 abuts against the insulating member 1. It is understood that the pole 4, the cover 22, and the insulating member 1 are inherently arranged in the battery. Arranging the insulating member 1 between the pole 4 and the cover 22 prevents the pole 4 from contacting the cover 22, such that a short circuit of the battery may be avoided. By arranging the sealing shell 35 to abut against the insulating member 1, the inherently arranged insulating structure may be taken to prevent the information obtaining component 3 from having the short circuit with the pole 4. In the present embodiment, the sealing shell 35 may be a metal shell. Of course, in this case, the sealing shell 35 needs to be insulated from the circuit board 32 and other electric structures, such as the power supply battery 31, such that the information obtaining component 3 may be prevented from being short-circuited by conductive substances carried by the electrolyte in the first receiving cavity. The sealing shell 35 may be spaced apart from the circuit board 32 and other electric structures to achieve insulation. Alternatively, an insulating layer may be arranged on an inner wall of the sealing shell 35. The sealing shell 35 may be a non-metallic shell. The non-metallic sealing shell 35 may be made of polyethylene glycol terephthalate (PET) or polypropylene (PP). The non-metallic sealing shell 35 may be formed by film blister moulding. Alternatively, the non-metallic sealing shell 35 may be an injection moulding shell, and high-frequency welding and ultrasonic operations may be performed to achieve insulation.

In the present embodiment, the sealing shell 35 is the non-metallic shell and abuts against the insulating member 1.

In some embodiments, the information obtaining component 3 is adhered to the cell 5. In the present embodiment, the information obtaining component 3 is adhered to the cell 5 by a tape. It is understood that the cell 5 includes an electrode sheet, a diaphragm and so on. The structure of the cell 5 is complex and includes electric elements. When the information obtaining component 3 is fixed to the electric core 5 by adhesion, the battery may be assembled less difficultly, and production cost of the battery may be reduced.

In the present embodiment, the detection signal line 34 of the information obtaining component 3 includes a pressure signal line 342 and a temperature signal line 341. The pressure signal line 342 is configured to collect a pressure of the cell 5, and the temperature signal line 341 is configured to collect a temperature of the cell 5.

In the present embodiment, the cell 5 has a mounting face 54 facing towards the cover 22. The mounting face 54 is arranged with the tab 53. The information obtaining component 3 is arranged on the mounting face 54. Two information obtaining components 3 may be arranged. The tab 53 is disposed between the two information obtaining components 3. In the present embodiment, the size of the battery is large. The two information obtaining components 3 are arranged to detect temperatures and pressures at various locations of the cell 5 more comprehensively, such that accuracy of the detection is improved. In other embodiments, the number of information obtaining components 3 is not limited to two, i.e., three, four or more information obtaining components 3 may be arranged. The number of information obtaining components 3 may be determined according to the actual demands of the battery.

The cell 5 includes the first cell pack 51 and the second cell pack 52. In an embodiment, one of the two information obtaining components 3 collects information of the first cell pack 51, and the other one of the two information obtaining components 3 collects information of the second cell pack 52. When the two information obtaining components 3 are arranged to collect information of the first cell pack 51 and the second cell pack 52 respectively, an operational state of the first cell pack 51 and an operational state of the second cell pack 52 may be determined independent from each other, and the state of the entire battery may be determined accordingly. In another embodiment, the two information obtaining components 3 cooperatively collect both the information of the first cell pack 51 and the information of the second cell pack 52. One of the two information obtaining components 3 collects information of a left region of the attachment face of the first cell pack 51 and the second cell pack 52, and the other one of the two information obtaining components 3 collects information of a right region of the attachment face of the first cell pack 51 and the second cell pack 52.

In the present embodiment, an outer periphery of the cell 5 is wrapped by a protective film 8. The battery further includes a bottom sheet 7 and a connector 6. The bottom sheet 7 and the connector 6 are both received in the first receiving cavity of the outer housing 2. The bottom sheet 7 is located at a bottom of the cell 5. The connector 6 is disposed between the cover 22 and the cell 5. The connector 6 is configured to connect the tab 53 of the cell 5 to the pole 4 on the cover 22. The circuit board 32 may be a printed circuit board (PCB). The wireless transmitting end 33 of the information obtaining component 3 is a signal transmitting antenna. The power supply battery 31 is a primary lithium battery, such as a lithium-manganese dioxide battery, a lithium thionyl chloride battery, and so on.

In the description herein, it is to be understood that the terms “up”, “down”, “left”, “right”, and so on indicate orientation or positional relationships shown in the accompanying drawings and are used only for the purpose of facilitating description and simplifying operations. These terms are not intended to indicate or imply that the device or the element must be constructed or operated in the particular orientation. Therefore, the terms shall not be interpreted as limitation of the present disclosure. In addition, the terms “first” and “second” are used only for describing distinguishing features and have no special meaning.

In the description of the present disclosure, the description with reference to the terms “embodiment”, “example”, and so on means that a specific feature, a structure, a material, or characteristic described in the embodiment or the example is included in at least one embodiment or example of the present disclosure. In the present specification, schematic expressions of the above terms do not necessarily refer to the same embodiment or example.

In addition, it should be understood that although the present specification is described in accordance with the embodiments, not each embodiment includes only one independent technical solution. The specification is described in such a manner merely for clarity. Any ordinary skilled person in the art shall take the specification as a whole. Technical solutions in various embodiments may be appropriately combined with each other to form other embodiments that may be understood by the ordinary skilled person in the art.

Technical principles of the present disclosure are described above by referring to specific embodiments. The description is only intended to explain the principles of the present disclosure and is not to limit the scope of the present disclosure. Based on the explanations herein, any other implementation, which is associated by any ordinary skilled person in the art without making creative work, shall fall within the scope of the present disclosure.

What is claimed is:

1. A battery, comprising an outer housing and a cell, wherein the cell is received in a first receiving cavity of the outer housing, the outer housing is arranged with an insulating member, and the battery is characterized by comprising:
at least one information obtaining component, received in the first receiving cavity and fixed to the cell, wherein each of the at least one information obtaining component comprises a detection assembly, a power supply battery, a wireless transmitting end and a circuit board; the detection assembly, the power supply battery, and the wireless transmitting end are electrically connected with each other via the circuit board; a detection end of the detection assembly is attached to the cell, the wireless transmitting end is disposed adjacent to the insulating member and is configured to transmit a signal, and the signal is capable of transmitting through the insulating member to reach an exterior of the first receiving cavity.

2. The battery according to claim 1, further comprising:
a pole, extending through the insulating member and the outer housing, wherein the insulating member is disposed between an end of the pole and the outer housing, the other end of the pole is received in the first receiving cavity; and the at least one information obtaining component is arranged on a side of the cell near the pole.

3. The battery according to claim 2, wherein, the detection assembly comprises a detection signal line;
an end of the detection signal line is connected to the circuit board, the other end of the detection signal line is arranged with the detection end;
the cell comprises a first cell pack and a second cell pack, the detection signal line is disposed between the first cell pack and the second cell pack;
the detection end is configured to detect information of a first attachment face of the first cell pack and information of a second attachment face of the second cell pack, and the attachment face is a surface to which the detection end is attached.

4. The battery according to claim 3, wherein a heat-homogenization plate is arranged on both the first cell pack and the second cell pack; the heat-homogenization defines an avoidance groove; and the detection signal line is received in the avoidance groove.

5. The battery according to claim 1, wherein each of the at least one information obtaining component further comprises a sealing shell; the sealing shell has a second receiving cavity; the power supply battery, the wireless transmitting end, and the circuit board are received in the second receiving cavity.

6. The battery according to claim 2, wherein each of the at least one information obtaining component further comprises a sealing shell; the sealing shell has a second receiving cavity; the power supply battery, the wireless transmitting end, and the circuit board are received in the second receiving cavity.

7. The battery according to claim 3, wherein each of the at least one information obtaining component further comprises a sealing shell; the sealing shell has a second receiving cavity; the power supply battery, the wireless transmitting end, and the circuit board are received in the second receiving cavity.

8. The battery according to claim 5, further comprising:
a pole, extending through the outer housing, wherein, the pole is connected to the cell, the sealing shell abuts against a circumferential face of the pole, and the sealing shell is insulated from the pole.

9. The battery according to claim 8, wherein, the sealing shell is non-metallic.

10. The battery according to claim 8, wherein, the insulating member is disposed between the pole and the outer housing, and the sealing shell abuts against the insulating member.

11. The battery according to claim 1, wherein the at least one information obtaining component is adhered to the cell.

12. The battery according to claim 2, wherein the at least one information obtaining component is adhered to the cell.

13. The battery according to claim 3, wherein the at least one information obtaining component is adhered to the cell.

14. The battery according to claim 4, wherein the at least one information obtaining component is adhered to the cell.

15. The battery according to claim 1, wherein the number of the at least one information obtaining component is at least two.

16. The battery according to claim 15, wherein, the number of the at least one information obtaining component is two, the cell has a mounting face, a tab is arranged on the mounting face, the two information obtaining components are arranged on the mounting face, the tab is disposed between the two information obtaining components.

17. The battery according to claim 15, wherein the cell comprises a first cell pack and a second cell pack; one of the two information obtaining components is configured to detect information on a first attachment face of the first cell pack; and the other one of the two information obtaining components is configured to detect information on a second attachment face of the second cell pack.

18. The battery according to claim 3, wherein, the detection signal line comprises a temperature signal line and a pressure signal line;
the information of the attachment face comprises a temperature of the attachment face and a pressure of the attachment face; and
the temperature signal line is configured to detect the temperature of the attachment face; and the pressure signal line is configured to detect the pressure of the attachment face.

19. The battery according to claim 4, wherein, the detection signal line comprises a temperature signal line and a pressure signal line;
the information of the attachment face comprises a temperature of the attachment face and a pressure of the attachment face; and
the temperature signal line is configured to detect the temperature of the attachment face; and the pressure signal line is configured to detect the pressure of the attachment face.

20. The battery according to claim 5, wherein, the detection signal line comprises a temperature signal line and a pressure signal line;
the information of the attachment face comprises a temperature of the attachment face and a pressure of the attachment face; and
the temperature signal line is configured to detect the temperature of the attachment face; and the pressure signal line is configured to detect the pressure of the attachment face.
